(19) United States
(12) Patent Application Publication
(10) Pub. No.: US 2016/0363647 A1
(43) Pub. Date: Dec. 15, 2016

(54) VEHICLE POSITIONING IN INTERSECTION USING VISUAL CUES, STATIONARY OBJECTS, AND GPS

(71) Applicant: GM GLOBAL TECHNOLOGY OPERATIONS LLC, Detroit, MI (US)

(72) Inventors: SHUQING ZENG, Sterling Heights, MI (US); Upali Priyantha Mudalige, Oakland Township, MI (US)

(21) Appl. No.: 14/739,789

(22) Filed: Jun. 15, 2015

(51) Int. Cl. G01S 5/02; G06K 9/00; G01S 15/02; G01S 19/42; G01S 13/02

(52) U.S. Cl. CPC G01S 5/0263; G01S 19/42; G01S 13/02; G01S 15/02; G06K 9/00818; G06K 9/00798

(57) ABSTRACT

A system and method for identifying the position and orientation of a vehicle. The method includes obtaining an environmental model of a particular location from, for example, a map database on the vehicle or a roadside unit. The method further includes detecting the position of the vehicle using GPS signals, determining range measurements from the vehicle to stationary objects at the location using radar sensors and detecting visual cues around the vehicle using cameras. The method includes registering the stationary objects and detected visual cues with stationary objects and visual cues in the environmental model, and using those range measurements to the stationary objects and visual cues that are matched in the environmental model to determine the position and orientation of the vehicle. The vehicle can update the environmental model based on the detected stationary objects and visual cues.

### BACKGROUND OF THE INVENTION

### Field of the Invention

This invention relates generally to a system and method for identifying the position and orientation of a vehicle and, more particularly, to a system and method for identifying the position and orientation of a vehicle at an intersection or during the occurrence of weak GPS signal reception, where the method uses visual cues provided by vehicle cameras and/or range measurements from stationary objects around the vehicle detected by radar sensors.

### Discussion of the Related Art

Object detection systems, also known as object sensing systems, have become increasingly common in modern vehicles. Object detection systems can provide a warning to a driver about an object in the path of a vehicle. Object detection systems can also provide input to active vehicle systems, such as adaptive cruise control systems, which control vehicle speed to maintain the appropriate longitudinal spacing to a leading vehicle, and rear cross traffic avoidance systems, which can provide both warnings and automatic braking to avoid a collision with an object behind a host vehicle when the host vehicle is backing up.

The object detection sensors for these types of systems may use any of a number of technologies, such as short range radar, long range radar, cameras with image processing, laser or Lidar, ultrasound, etc. The object detection sensors detect vehicles and other objects in the path of a subject vehicle, and the application software uses the object detection information to provide warnings or take actions as appropriate. The warning can be a visual indication on the vehicles instrument panel or in a head-up display (HUD), and/or can be an audio warning or other haptic feedback device, such as haptic seat. In many vehicles, the object detection sensors are integrated directly into the front bumper or other fascia of the vehicle.

Radar and Lidar sensors that may be employed on vehicles to detect objects around the vehicle and provide a range to and orientation of those objects provide reflections from the objects as multiple scan points that combine as a point cluster range map, where a separate scan point is provided for every ½° across the field-of-view of the sensor. Therefore, if a target vehicle or other object is detected in front of the subject vehicle, there may be multiple scan points that are returned that identify the distance of the target vehicle from the subject vehicle. By providing a cluster of scan return points, objects having various and arbitrary shapes, such as trucks, trailers, bicycle, pedestrian, guard rail, K-barrier, etc., can be more readily detected, where the bigger and/or closer the object to the subject vehicle the more scan points are provided.

Cameras on a vehicle may provide back-up assistance, take images of the vehicle driver to determine driver drowsiness or attentiveness, provide images of the road as the vehicle is traveling for collision avoidance purposes, provide structure recognition, such as roadway signs, etc. Other vehicle vision applications include vehicle lane sensing systems to sense the vehicle travel lane and drive the vehicle in the lane-center. Many of these known lane sensing systems detect lane-markers on the road for various applications, such as lane departure warning (LDW), lane keeping (LK), lane centering (LC), etc., and have typically employed a single camera, either at the front or rear of the vehicle, to provide the images that are used to detect the lane-markers.

It is also known in the art to provide a surround-view camera system on a vehicle that includes a front camera, a rear camera and left and right side cameras, where the camera system generates a top-down view of the vehicle and surrounding areas using the images from the cameras, and where the images overlap each other at the corners of the vehicle. The top-down view can be displayed for the vehicle driver to see what is surrounding the vehicle for back-up, parking, etc. Future vehicles may not employ rearview mirrors, but may instead include digital images provided by the surround view cameras.

Various vehicle systems require that the position and orientation of the vehicle be known. Currently, modern vehicles typically rely on GPS signals to identify vehicle location, which is necessary for various vehicle systems, such as navigation systems, etc. However, current GPS receivers on vehicles are not always able to receive GPS signals as a result of interference and blocking of the signals from, for example, tall buildings, infrastructure, etc., thus having a detrimental affect on those systems that require vehicle positioning. Hence, it would be advantageous to provide additional reliable techniques for determining the position of a vehicle in areas of weak GPS reception.

### SUMMARY OF THE INVENTION

The following disclosure describes a system and method for identifying the position and orientation of a vehicle. The method includes obtaining an environmental model of a particular location from, for example, a map database on the vehicle or a roadside unit. The method further includes detecting the position of the vehicle using GPS signals, determining range measurements from the vehicle to stationary objects at the location using radar sensors and detecting visual cues around the vehicle using cameras. The method includes registering the stationary objects and detected visual cues with stationary objects and visual cues in the environmental model, and using those range measurements to the stationary objects and visual cues that are matched in the environmental model to help determine the position and orientation of the vehicle. The vehicle can update the environmental model based on the detected stationary objects and visual cues.

Additional features of the present invention will become apparent from the following description and appended claims, taken in conjunction with the accompanying drawings.

### BRIEF DESCRIPTION OF THE DRAWINGS

FIG. 1 is an illustration of a roadway intersection;

FIG. 2 is an environmental model of the intersection shown in FIG. 1;

FIG. 3 is a simplified block diagram of a technique for updating and revising the environmental model shown in FIG. 2;

FIG. 4 is a block diagram of a system for obtaining vehicle position based on the environmental model; and

FIG. 5 is a block diagram of a system for object and landmark detection.

### DETAILED DESCRIPTION OF THE EMBODIMENTS

The following discussion of the embodiments of the invention directed to a system and method for identifying vehicle position and orientation by fusing data from GPS signals, visual cues detected by vehicle cameras and stationary objects detected by radar sensors is merely exemplary in nature, and is in no way intended to limit the invention or its applications or uses. For example, as discussed, the system and method has particular application for identifying vehicle position. However, as will be appreciated by those skilled in the art, the system and method may have application for other mobile platforms, such as on trains, machines, tractors, boats, recreation vehicles, etc.

As will be discussed in detail below, the present invention proposes a system and method for identifying vehicle position and orientation for various vehicle systems, such as collision avoidance systems, navigation systems, etc., by fusing data and range measurements from GPS signals, visual cues and/or stationary objects. The discussion and description below of the system and method will be directed specifically toward determining vehicle position and orientation at an intersection, where GPS signals may be weak as a result of structural elements blocking the signals and the occurrences of vehicle collisions may be higher, and where an intersection typically includes various and many stationary objects, such as sign, and visual cues that can be employed to determine the location of the vehicle. However, it is stressed that the system and method of the invention as discussed herein can be employed at many other locations and environments. As used herein, visual cues are statistic or pattern that can be extracted from an image captured by cameras, that indicates the state of some property of the environment that the automated vehicle is interested in perceiving. A visual cue is a small blob usually described as a position (row and column in an image) and feature descriptor (a binary vector that can uniquely identity the blob). Examples of visual cues may be scale-invariant feature transform (SIFT), features from accelerated segment test (FAST), binary robust independent elementary features (BRIEF), and oriented fast and rotated (ORB) BRIEF.

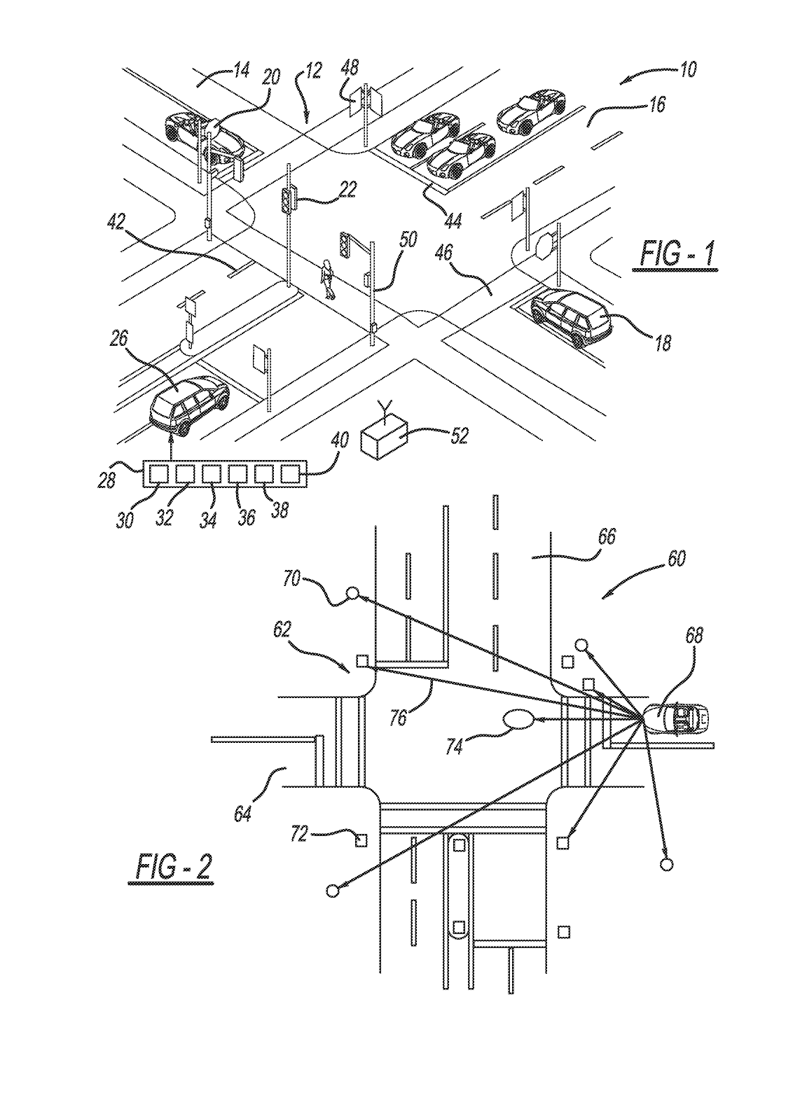

FIG. 1 is an illustration 10 of an intersection 12 defined by crossing roadways 14 and 16. Several vehicles 18 are shown stopped at the intersection 12, where vehicles 18 traveling along the roadway 14 are subject to stop signs 20 and vehicles 18 traveling along the roadway 16 are subject to traffic lights 22. One of the vehicles 18 is designated in the illustration 10 as a host vehicle 26 and includes various hardware and software elements 28 required to perform the various operations discussed herein. For example, the elements 28 may include a processor 30, a map database 32, cameras 34, including top-down view cameras, object sensors 36, such as radar, Lidar, etc., a GPS receiver 38 and a short range communications system 40.

As will be discussed herein, the GPS receiver 38 will receive GPS satellite signals, the cameras 34 will detect visual cues around the host vehicle 26, such as lane markings 42, stop bars 44, cross walk lines 46, etc., and the sensors 36 will detect stationary objects, such as roadway signs 48, posts 50, the stop signs 20, the traffic lights 22, etc. The processor 30 will use one or more of these signals to generate an environmental model of the intersection 12, and other intersections or locations, that is stored in the map database 32, and can be used to identify the location and orientation of the vehicle 26 in and around the intersection 12 based on distance or range measurements from the vehicle 26 to these various visual cues and objects. Further, the short range communications system 40 on the vehicle 26 can transmit data to and receive data from a roadside unit 52 that also stores the environmental model so that as the environmental model is updated in the roadside unit 52 by the host vehicle 26, or other vehicles 18 having the same capability as the host vehicle 26, that updated information can be shared with the host vehicle 26 to provide a more accurate depiction of its location, especially during the occurrence of nonexistent or weak GPS signals.

FIG. 2 is an environmental model 60 made of the illustration 10 that is generated based on information received by the host vehicle 26 from the visual cues and stationary objects, where the model 60 illustrates the intersection 12 as intersection 62, the roadway 14 as roadway 64, the roadway 16 as roadway 66, and the host vehicle 26 as host vehicle 68. In the model 60, circles 70 represent GPS satellites that the host vehicle 68 receives GPS signals from, squares 72 represent the stationary objects that the vehicle 68 identifies and ovals 74 represent the visual cues that are detected. The arrows 76 in the model 60 identify the determined range from these various things, which are then fused together to identify the specific location and orientation of the host vehicle 68. Obtaining all of the sensor information as discussed herein allows the host vehicle 26 to be localized to the global coordinates.

Because it is likely that the host vehicle 26 will repeatedly travel along the same route, such as going from home to work and vice versa, the several environmental models that may be stored in the map database 32 or the roadside unit 52 can be updated as the host vehicle 26 travels along the route based on the most recent detection of the stationary objects and the visual cues. Therefore, the environmental model is continually being updated by adding objects that may be new and removing objects that may be gone. By knowing the location of the stationary objects and the visual cues, range finding sensors on the host vehicle 26 can determine the vehicle's location and orientation based on the distance that the host vehicle 26 is from those objects. As the host vehicle 26 detects the various stationary objects along its route and those objects correspond to existing objects already present in the environmental model stored in the database 32 or the roadside unit 52, the vehicle 26 can use those stationary objects to identify the specific location and orientation of the vehicle 26. Thus, new objects can be added to the environmental model and removed objects can be eliminated from the environmental model as those new objects are repeatedly detected as the host vehicle 26 travels along its normal route or a particular object that was once repeatedly detected and now is repeatedly not detected can be removed.

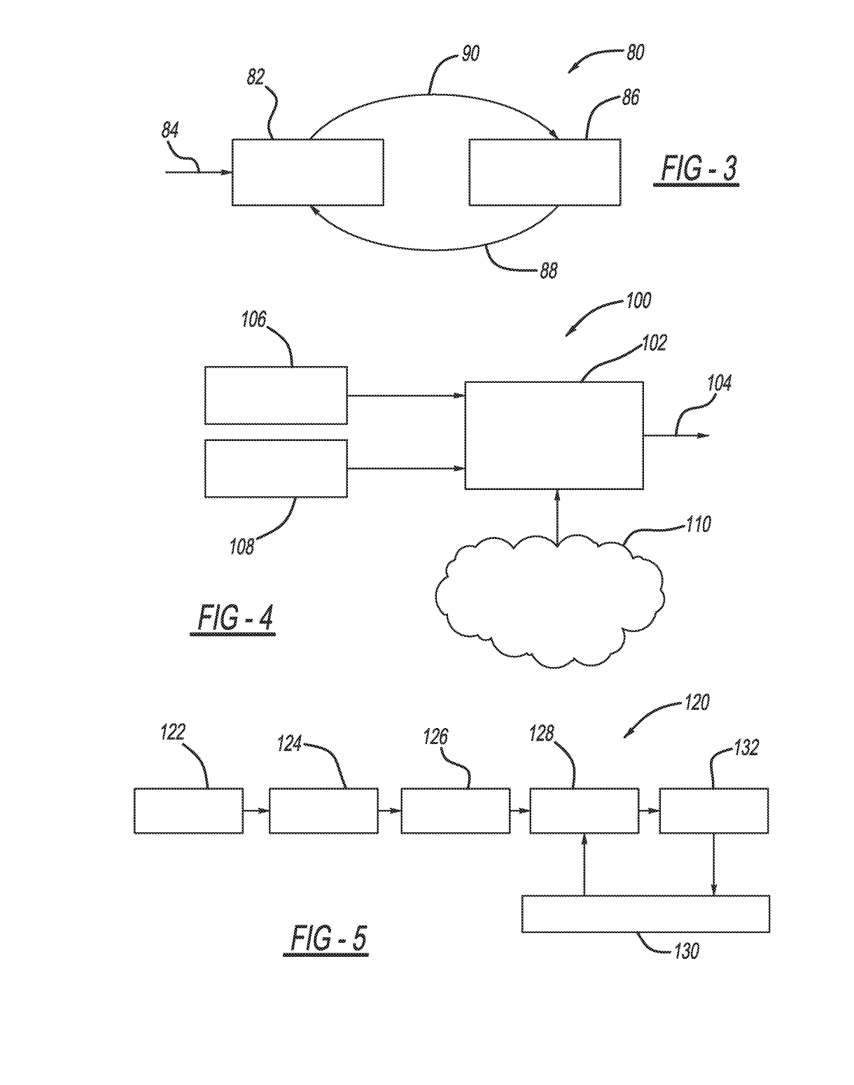

FIG. 3 is simplified flow diagram 80 showing a process for updating the position and orientation of the host vehicle 26 that is performed at box 82, which receives range measurements of the stationary objects and detected visual cues on line 84. The vehicle position and orientation determination algorithm also receives the environmental model 60 identified at box 86 on line 88 from, for example, the roadside unit 52 or the map database 32. The algorithm calculates the updated environmental model based on the existing environmental model and the newly detected signals, and provides that data to update the environmental model 60 at box 86 on line 90.

FIG. 4 is a block diagram of a system 100 that provides vehicle position, heading angle and velocity in the manner as discussed herein. Block 102 represents a processor, such as the processor 30 on the host vehicle 26, that performs and operates the various processes and algorithms necessary to provide vehicle position, heading angle and velocity, whose signals are provided on line 104. The processor 102 receives vehicle kinematic data from suitable vehicle sensors 106, such as vehicle speed, vehicle yaw rate, steering wheel angle, etc. The processor 102 also receives range measurement signals from sensors and receivers 108, such as GPS signals, detected stationary objects, such as from radar sensors, detected visual cues, such as roadway markings from vehicle cameras, etc. The processor 102 also receives and downloads an environmental model 110 from the roadside unit 52. The processor 102 matches the detected objects and visual cues with those in the environmental model 110, and finds the vehicle pose where the sensor data best matches the objects in the environmental model 110. The processor 102 also registers and updates the stationary roadside objects and visual cues to provide an updated environmental model that is transmitted back to the roadside unit 52.

FIG. 5 is a block diagram of a system 120 providing additional detail as to how the host vehicle 26 provides stationary object detection. As mentioned, stationary objects are detected by radar or Lidar sensors, which provides a number of scan points when a particular object is detected, represented by box 122. The scan points are then processed at box 124 to provide point clustering, well known to those skilled in the art, to identify the range, range rate and angle of a particular object that is detected. The detection algorithm then determines if the detected object is stationary, i.e., has not moved from one sample point to another sample point, at box 126. At box 128, the algorithm matches or registers the detected stationary objects to those objects in the environmental model provided at box 130 to insure that the detected objects are existing stationary objects. The algorithm then outputs signals identifying the matched stationary objects whose persistency index is larger than a predetermined threshold at box 132. The persistency index identifies how often the particular object is detected as the vehicle 26 may travel the route repeatedly. In this way, the algorithm detects roadside objects whose size is less than 1 meter, and whose ground speed is zero and that is not near other stationary objects. The algorithm determines the range and bearing angle of the detected objects in the coordinate frame of the host vehicle 26. Once the stationary objects are detected that are larger than the threshold, the host vehicle 26 sends the revised or updated environmental model back to the roadside unit 52.

The visual cue detection algorithm may employ a surround view camera system for detecting lane markings around the host vehicle 26 and may use, for example, a forward-view camera to identify visual cues above the vanishing line of the image, where the detection algorithm determines a bearing angle for each detected cue. If the algorithm is able to determine the bearing angle of two or more visual cues, then triangulation calculations can be employed to determine the range to those visual cues.

The following discussion provides a more detailed explanation of how the positioning algorithm discussed above uses the range and bearing measurements to determine the location and orientation of the host vehicle 26. An information array is used to represent a Gaussian distribution as:

p˜N(μ,Σ), (1)

p˜[R, z], (2)

where:

R^{T}R=Σ⁻¹ (3)

Rp=z. (4)

For the discussion herein, the local east-north-up (ENU) coordinate frame is used to represent the position of the vehicle 26. Sensor measurements are acquired as ρ₁, ρ₂, . . . , ρ_{M}, where each sensor measurement could be a range or bearing angle for a stationary object or a visual cue. From these measurements, let ρ₁, ρ₂, . . . , ρ_{M} be the associated position in the environmental model 60. An initialization process is performed when the host vehicle 26 enters the environmental model 60, and acquires the position measurements ρ₁, ρ₂, . . . , ρ_{M}, where the update p=(X, Y, X)^{T} is computed using a least—squares calculation process having L iterations.

Let the initial position of the host vehicle 26 be:

\tilde{p}=(\tilde{X}, \tilde{Y}, \tilde{Z})^{T}=Σⱼ₌₁^{M}pⱼ/M. (5)

For illustration purposes, consider two measurements ρ₁ (range) and ρ₂ (bearing), where σ₁ and σ₂ are the corresponding standard of deviations for the two measurements, respectively, as:

\tilde{p}ⱼ=(Xⱼ, Yⱼ, Zⱼ)^{T} for j=1,2. (6)

Let:

$$\begin{matrix}{\tilde{ρ}}_{1} = \sqrt{{( \tilde{X} - {X}_{1} )}^{2} + {( \tilde{Y} - {Y}_{1} )}^{2} + {( \tilde{Z} - {Z}_{1} )}^{2}} , & ( 7 ) \\ {\tilde{ρ}}_{2} = arctan ( \frac{\tilde{Y} - {Y}_{2}}{\tilde{X} - {X}_{2}} ) , & ( 8 ) \\ {r}^{2} = {( \tilde{X} - {X}_{2} )}^{2} + {( \tilde{Y} - {Y}_{2} )}^{2} , & ( 9 ) \\ ( \begin{matrix}\frac{\overline{X} - {X}_{1}}{\tilde{{ρ}_{1}} {σ}_{1}} & \frac{\overline{Y} - {Y}_{1}}{\tilde{{ρ}_{1}} {σ}_{1}} & \frac{\overline{Z} - {Z}_{1}}{\tilde{{ρ}_{1}} {σ}_{1}} \\ - \frac{\overline{Y} - {Y}_{2}}{{r}^{2} {σ}_{2}} & \frac{\overline{X} - {X}_{2}}{{r}^{2} {σ}_{2}} & 0\end{matrix} ) ( \begin{matrix}X - \tilde{X} \\ Y - \tilde{Y} \\ Z - \tilde{Z}\end{matrix} ) = ( \begin{matrix}\frac{{ρ}_{1} - {\tilde{ρ}}_{1}}{{σ}_{1}} \\ \frac{{ρ}_{2} - {\tilde{ρ}}_{2}}{{σ}_{2}}\end{matrix} ) . & ( 10 )\end{matrix}$$

In matrix form:

H(p−\tilde{p})=Δρ, (11)

or:

Hp=o, (12)

where:

o=H\tilde{p}+Δρ. (13)

Construct the matrix [H o] and apply QR to it to get the triangular matrix

$$[ \begin{matrix}{R}_{0} & {Z}_{0} \\ 0 & e\end{matrix} ] ,$$

where scalar e is the residue.

The correct initial position is:

p₀=(R₀)⁻¹z₀. (14)

The distribution is:

p₀˜[R₀,z₀]. (15)

Let \tilde{p}=p₀, then loop the least-squares for at most L iterations (five) or when convergence is reached.

As discussed above, the positioning algorithm determines the location of the host vehicle 26 at every predetermined sample point. The present invention also proposes a position tracking algorithm that allows the position of the vehicle 26 to be tracked between two sample points. The following is a discussion of how the position tracking algorithm performs the position tracking. Input measurements, and the corresponding position are provided as:

ρ₁, ρ₂, . . . , ρ_{M}, (16)

p₁, p₂, . . . , p_{M}. (17)

The predict vehicle position is:

\tilde{p}=(\tilde{X}, \tilde{Y}, \tilde{Z})^{T}, (18)

and the prior distribution is:

p˜[\tilde{R}, \tilde{z}]. (19)

The posterior distribution for vehicle position is:

p˜[\hat{R}, \hat{z}], (20)

and the updated position is:

\hat{p}=\hat{R}⁻¹\hat{z}. (21)

The predicted vehicle position \hat{p} at the next time step, with the prior distribution is:

p˜\tilde{R},\tilde{z}. (22)

If this is initial step then:

\hat{p}=o₀, (23)

and the posterior distribution is:

p˜[R₀,z₀], (24)

Constructing the matrix:

$$( \begin{matrix}\tilde{R} & \tilde{z} \\ H & o\end{matrix} ) , \qquad ( 25 )$$

and applying QR decomposition, the upper triangular matrix is obtained as:

$$( \begin{matrix}\hat{R} & \hat{z} \\ 0 & e\end{matrix} ) , \qquad ( 26 )$$

where e is the least-squares residue.

The updated position at time t is:

\hat{p}=\hat{R}⁻¹\hat{z}, (27)

with the posterior distribution in information array form is:

p˜[\hat{R}, \hat{z}]. (28)

Given the best-effort estimate of position \hat{p} at time t, with distribution p˜[\hat{R}, \hat{z}], the prediction position at t+Δt is modeled as:

\tilde{p}=f(\hat{p}, v)+w, (29)

where v is the velocity vector including speed and yaw rate from vehicle sensors, w is the Gaussian noise vector with zero-mean and unity covariance.

Linearize the above nonlinear dynamic equation into the neighborhood of \hat{p} as:

F\tilde{p}+G\hat{p}=u+w, (30)

where matrices Fand Gare Jacobians

$$\frac{\partial f}{\partial \tilde{p}} and \frac{\partial f}{\partial \hat{p}} ,$$

respectively.

Construct the matrix:

$$( \begin{matrix}\hat{R} & 0 & \hat{z} \\ G & F & u\end{matrix} ) , \qquad ( 31 )$$

and applying QR decomposition to it, the upper triangular matrix is obtained as:

$$( \begin{matrix}α & β & γ \\ 0 & \tilde{R} & \tilde{z}\end{matrix} ) , \qquad ( 32 )$$

The predicted position is:

\tilde{p}=\tilde{R}⁻¹\tilde{z}, (33)

and the position is distributed as:

p˜[\tilde{R},\tilde{z}]. (34)

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for identifying a position and orientation of a mobile platform at a particular location, said method comprising:
obtaining an environmental model that includes stationary objects and visual cues at the particular location;
detecting stationary objects at the particular location using sensors on the mobile platform;
determining a distance from the mobile platform to stationary objects detected by the sensors;
detecting visual cues around the mobile platform;
matching the stationary objects detected by the sensors and the detected visual cues with stationary objects and visual cues in the environmental model; and
identifying the position and orientation of the mobile platform using the distance of the matched stationary objects and the matched visual cues.

2. The method according to claim 1 further comprising detecting the position of the mobile platform using GPS signals, wherein identifying the position and orientation of the mobile platform includes combining the detected position of the mobile platform using the GPS signals, the matched stationary objects and the matched visual cues.

3. The method according to claim 1 wherein detecting visual cues around the mobile platform includes using one or more cameras on the vehicle.

4. The method according to claim 3 wherein detecting visual cues around the mobile platform includes using a top down camera system.

5. The method according to claim 1 wherein determining the distance from the mobile platform to stationary objects includes using radar sensors or Lidar sensors on the mobile platform.

6. The method according to claim 1 wherein obtaining the environmental model includes obtaining the environmental model from a map database on the mobile platform.

7. The method according to claim 1 wherein obtaining the environmental model includes obtaining the environmental model from a roadside unit located at the particular location.

8. The method according to claim 1 wherein detecting stationary objects at the particular location includes determining that the stationary objects are stationary by the distance to the stationary objects from one sample point to another sample point.

9. The method according to claim 1 wherein identifying the position and orientation of the mobile platform also includes using mobile platform speed and yaw rate data.

10. The method according to claim 1 further comprising updating the environmental model by adding detected stationary objects that are not in the model and removing undetected stationary objects that are in the model.

11. The method according to claim 1 wherein the particular location is an intersection.

12. The method according to claim 11 wherein the stationary objects include light poles or sign posts.

13. The method according to claim 11 wherein the visual cues include lane markings, crosswalks or stop bars.

14. The method according to claim 11 wherein the visual cues include objects above a vanishing line.

15. The method according to claim 1 further comprising tracking the position of the mobile platform as it travels between sample points.

16. The method according to claim 1 wherein the mobile platform is a vehicle.

17. A method for identifying a position and orientation of a vehicle at an intersection, said method comprising:
obtaining an environmental model that includes stationary objects and visual cues at the particular location, wherein the stationary objects include light poles or sign posts and the visual cues include lane markings, crosswalks or stop bars;
detecting stationary objects at the particular location using radar or Lidar sensors on the vehicle;
determining a distance from the vehicle to stationary objects detected by the sensors;
detecting visual cues around the vehicle using one or more cameras on the vehicle;
matching the stationary objects detected by the sensors and the detected visual cues with stationary objects and visual cues in the environmental model;
detecting the position of the vehicle using GPS signals; and
identifying the position and orientation of the vehicle using the GPS signals, the distance of the matched stationary objects and the matched visual cues.

18. The method according to claim 17 wherein identifying the position and orientation of the mobile platform also includes using mobile platform speed and yaw rate data.

19. A system for identifying a position and orientation of a vehicle at a particular location, said system comprising:
means for obtaining an environmental model that includes stationary objects and visual cues at the particular location;
means for detecting stationary objects at the particular location using radar or Lidar sensors on the vehicle;
means for determining a distance from the vehicle to stationary objects detected by the sensors;
means for detecting visual cues around the vehicle using one or more cameras;
means for matching the stationary objects detected by the sensors and the detected visual cues with stationary objects and visual cues in the environmental model;
means for detecting the position of the vehicle using GPS signals; and
means for identifying the position and orientation of the vehicle using the distance of the matched stationary objects and the matched visual cues.

20. The system according to claim 19 further comprising means for detecting the position of the vehicle using GPS signals, wherein identifying the position and orientation of the vehicle includes combining the detected position of the vehicle using the GPS signals, the matched stationary objects and the matched visual cues.
